(19) United States
(12) Patent Application Publication
(10) Pub. No.: US 2017/0216773 A1
(43) Pub. Date: Aug. 3, 2017

(54) METHODS FOR SEPARATING MIXTURES

(71) Applicants: UNIVERSITY OF IOWA RESEARCH FOUNDATION, Iowa City, IA (US); BATTELLE ENERGY ALLIANCE, LLC, Idaho Falls, ID (US)

(72) Inventors: Michael K. Schultz, Iowa city, IA (US); Andrew W. Knight, Iowa City, IA (US); Eric S. Eitrheim, Iowa City, IA (US); Peter R. Zalupski, Idaho Falls, ID (US)

(73) Assignees: UNIVERSITY OF IOWA RESEARCH FOUNDATION, Iowa City, IA (US); BATTELLE ENERGY ALLIANCE, LLC, Idaho Falls, ID (US)

(21) Appl. No.: 15/500,448

(22) PCT Filed: Jul. 28, 2015
(86) PCT No.: PCT/US2015/042526

§ 371 Date: Jan. 30, 2017

Related U.S. Application Data
(60) Provisional application No. 62/030,464, filed on Jul. 29, 2014.

(51) Int. Cl. B01D 59/26; G21F 9/12; G21F 9/00; C22B 58/00; C01G 15/00; B01J 20/20; B01J 20/28; B01J 20/282; B01D 15/08; C01G 99/00

(52) U.S. Cl. CPC B01D 59/26; B01D 15/08; G21F 9/12; G21F 9/007; C01G 99/003; C01G 15/003; B01J 20/20; B01J 20/28083; B01J 20/282; C22B 58/00; G21Y 2002/60; G21Y 2002/10; G21Y 2004/20; B01J 2220/52

(57) ABSTRACT

This application discloses the method for separating element or isotopes such as protactinium and gallium and isotopes thereof from a corresponding mixture which method comprises contacting the mixture with a carbon-based separation material, wherein the carbon-based separation material selectively associates with the element or isotope thereof.

### RELATED APPLICATION

This application claims priority to U.S. Provisional Patent Application No. 62/030,464, filed Jul. 29, 2014, the entirety of which is incorporated herein by reference.

### GOVERNMENT SUPPORT

This invention was made with government support under NRC-HQ-12-G-38-0041 awarded by the United States Nuclear Regulatory Commission, 2012-DN-130-NF00001 awarded by the United States Department of Homeland Security and DE-AC07-051D14517 awarded by the United States Department of Energy. The government has certain rights in the invention.

### BACKGROUND OF THE INVENTION

Nuclear power plants continue to supply a significant portion of electricity throughout the world. Additionally, as fossil fuel consumption over the next few decades will be challenged to meet global energy demands and environmental regulations, the nuclear power industry can be seen as a viable option of relief. Yet, major concerns of nuclear energy and lack of innovation have slowed its growth. These primary concerns are the accumulation of long-term radioactive waste, energy intensive fuel production process, and the potential to mask a weapons program.

There is a need to sequester protactinium (Pa) from high-level radioactive material, which can greatly decrease the radioactivity (because of ingrowth of short-lived decay products) and storage time of spent nuclear fuel from power plants. It would be advantageous to decrease the long-term storage requirements of the waste as this would reduce storage cost, improve safety and re-open the possibility to storing the waste in a geological repository. This can be achieved through the separation of longer half-life radioisotopes such as Pa radioisotopes (e.g., ²³¹Pa; half-life=32,900 years and ²³³Pa; half-life=26.9 days) from other components of the relevant waste stream such as actinides (e.g., Th, U, Np, Pu and Am), decay products and other environmental interferences (e.g., other metals).

Nuclear fuel production would also benefit from methods directed to sequestering Pa. This benefit can be utilized for fuel production for conventional light water reactors, using ²³⁵U-enriched fuel, as well as for thorium breeder reactors to produce ²³³U fuel. In light water reactors, Pa contamination in ²³⁵U fuel decreases the purity of the uranium fuel and thus lowers the energy output of the uranium fuel. It is suspected that the lower efficiency is caused by Pa acting as a neutron poison. Accordingly, improved methods to remove Pa during ²³⁵U production would be beneficial. For the case of thorium breeder reactors, fertile ²³²Th undergoes nuclear transmutation to form the fissile isotope ²³³U through the intermediates ²³³Th and ²³³Pa. By improving the purity of the ²³³U fuel the resultant energy output from the fuel can be increased. One method to improve the purity of the ²³³U fuel involves purifying the intermediate ²³³Pa to act as a ²³³U fuel generator as it decays (˜5 months).

One persistent problem that prevents efficient and predictable separations involving fuel production and radioactive fuel waste management is radiolytic damage of the components of the extraction process including the extraction solvents. These degradation processes negatively impact the efficiency of the extractions. Thus, in addition to improved separation methods for extracting Pa from radioactive waste streams it would also be advantageous to have separation materials and methods that are also less susceptible to the negative effects of radiolysis.

Positron emission tomography (PET) is important in medical imaging and is commonly performed using gallium-68 (⁶⁸Ga). Gallium-68 which has a half-life of 68 minutes is obtained from ⁶⁸Ga generator and is purified by extraction chromatography. Purification is important to remove the parent isotope, germanium-68 (⁶⁸Ge). The purification from ⁶⁸Ge is critical to ensure that the patients received dose is correct. As ⁶⁸Ga has a short half-life there is a need to for separation methods that are efficient and can be done quickly so as to maximize the intensity of the imaging agent upon administration to the patient. There is also need for separation methods that allow the ⁶⁸Ga to be obtained in a biologically relevant buffer. This allows for conjugation of the ⁶⁸Ga to a biomolecule such as a peptide while minimizing or eliminating timely chemical adjustment steps.

Accordingly, there is a need to develop improved methods to separate Pa and isotopes thereof (e.g., ²³³Pa and ²³¹Pa) from mixtures that comprise Pa. Likewise, there is a need to separate Ga and isotopes (e.g., ⁶⁸Ga) thereof from mixtures that comprise Ga and isotopes thereof. There is also a need to develop separation methods that are not negatively impacted under the conditions of the separation (e.g., degradation by radiolysis).

### SUMMARY OF THE INVENTION

Applicant has discovered that certain separation materials (e.g., carbon-based separation materials such as mesoporous carbon-based materials) are useful for separating certain elements and isotopes thereof (e.g., ^{233,231}Pa and ⁶⁸Ga) from mixtures containing the element. The resultant separation methods can be focused on separating the element from the mixture so as to obtain the element in pure or enriched form. Conversely, the separation methods can be focused on removing the element from the mixture so as to obtain a mixture that is devoid or has a lowered amount of the element. In some embodiments it is desirable that both (1) the element be purified or obtained in enriched form and (2) the mixture be obtained that is devoid in the element or has a lowered amount of the element. In addition to the high selectivity of the separation material for the element (e.g., ^{233,231}Pa and ⁶⁸Ga), the separation materials also provide shielding properties in separations involving nuclear fuel applications (such as extractions involving spent nuclear fuel). This shielding reduces the effects of radiolysis. Due to the shielding character of the macro-structure, the effects of radiolysis in nuclear fuel applications are reduced and extractions from spent and processed nuclear fuel are more feasible.

Accordingly, one embodiment provides a method for separating an element or isotopes thereof from a corresponding mixture comprising the element or isotopes thereof, which method comprises contacting the mixture with a carbon-based separation material, wherein the carbon-based separation material selectively associates with the element or isotope thereof.

One embodiment provides a method for separating Pa or Ga or isotopes thereof (e.g., ^{233,231}Pa and ⁶⁸Ga) from a corresponding mixture comprising the Pa or Ga or isotopes thereof, which method comprises contacting the mixture with a carbon-based separation material.

One embodiment provides a composition comprising an element or isotopes thereof and a carbon-based separation material.

### BRIEF DESCRIPTION OF THE FIGURES

FIG. 1 illustrates the elution curve profile showing the separation of Pa from the other actinides and interferences.

FIG. 2 illustrates a coated separation material (e.g., carbon-based separation material) such as a particle. FIG. 2A illustrates a fully coated separation material; FIG. 2B illustrates a partially coated separation material; and FIG. 2C illustrates a partially coated separation material wherein the coating is non-contiguous (for example spotted).

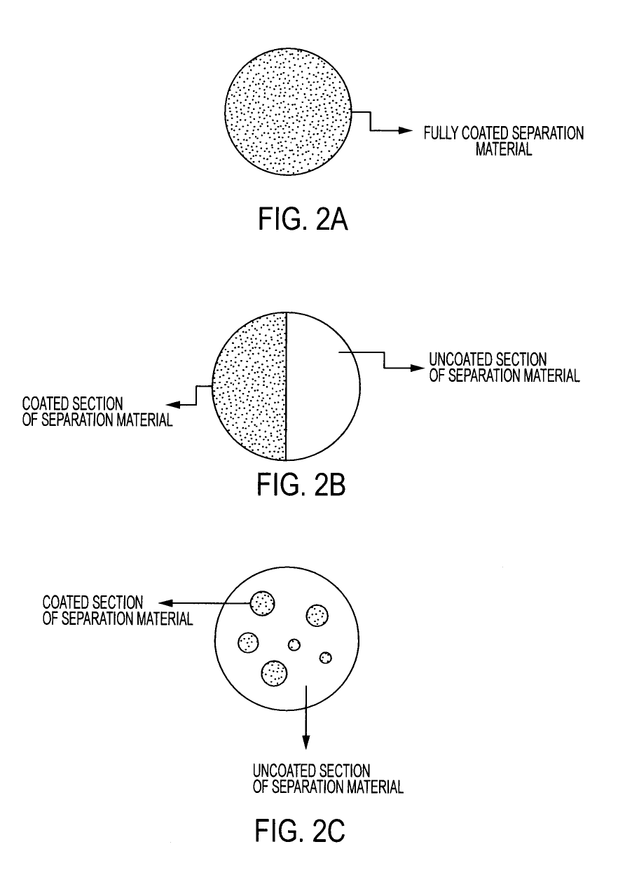

### DETAILED DESCRIPTION

Separation Materials.

The separation materials including carbon-based separation materials used in the separations described herein are useful for separating certain elements and isotopes thereof (e.g., ^{233,231}Pa and ⁶⁸Ga) from a mixture containing the element. As used herein the term “element” refers to an element and all isotopes of that element unless a specific isotope is recited. In one embodiment the separation material is a carbon-based separation material. As used here the term “carbon-based separation material” includes materials comprising carbon (e.g., materials that are substantially made up of carbon). In one embodiment the carbon-based separation material is composed of a plurality of carbon atoms wherein a plurality of the carbon atoms are bonded together by carbon-carbon bonds (e.g., bonded together by bonds such as covalent bonds). In one embodiment the carbon-based separation material is composed of a plurality of carbon atoms wherein essentially all of the carbon atoms are bonded together by carbon-carbon bonds (e.g., bonded together by bonds such as covalent bonds). Examples of carbon-based separation materials include but are not limited to graphene, carbon-nanotubes, mesoporous carbon, carbon nanofibers, and carbon nanofoams. In one embodiment the carbon-based separation material does not include inorganic carbon materials (e.g., as the bulk material not including any surface coating and/or the bulk material including a surface coating) which includes for example metal carbonates. In one embodiment the carbon-based separation material is greater than or about equal to 20% carbon by weight. In one embodiment the carbon-based separation material is greater than or about equal to 30% carbon by weight. In one embodiment the carbon-based separation material is greater than or about equal to 40% carbon by weight. In one embodiment the carbon-based separation material is greater than or about equal to 50% carbon by weight. In one embodiment the carbon-based separation material is greater than or about equal to 60% carbon by weight. In one embodiment the carbon-based separation material is greater than or about equal to 70% carbon by weight. In one embodiment the carbon-based separation material is greater than or about equal to 80% carbon by weight. In one embodiment the carbon-based separation material is greater than or about equal to 90% carbon by weight. In one embodiment the carbon-based separation material is greater than or about equal to 95% carbon by weight. In one embodiment the carbon-based separation material is greater than or about equal to 99% carbon by weight. In one embodiment the carbon-based separation material is about 100% carbon by weight. In one embodiment the carbon-based separation material is greater than or about equal to 20% carbon by composition. In one embodiment the carbon-based separation material is greater than or about equal to 30% carbon by composition. In one embodiment the carbon-based separation material is greater than or about equal to 40% carbon by composition. In one embodiment the carbon-based separation material is greater than or about equal to 50% carbon by composition. In one embodiment the carbon-based separation material is greater than or about equal to 60% carbon by composition. In one embodiment the carbon-based separation material is greater than or about equal to 70% carbon by composition. In one embodiment the carbon-based separation material is greater than or about equal to 80% carbon by composition. In one embodiment the carbon-based separation material is greater than or about equal to 90% carbon by composition. In one embodiment the carbon-based separation material is greater than or about equal to 95% carbon by composition. In one embodiment the carbon-based separation material is greater than or about equal to 99% carbon by composition. In one embodiment the carbon-based separation material is about 100% carbon by composition. In one embodiment the carbon-based separation material is not charcoal.

The separation material (e.g., carbon-based separation material) may have an ordered structure (e.g., an ordered crystalline structure). The separation material (e.g., carbon-based separation material) may be amorphous. The separation material may be fashioned or formed to any suitable shape or form that allows for the separation to occur. Non-limiting examples of such forms of the separation material (e.g., carbon-based separation material) includes particles, beads, molecular sieves, disks, frits and sheets. The separation materials can also be formed into membranes of any shape (e.g., spiral wound membranes) and can also include a plurality of membranes (e.g., membranes of two or more layers).

The separation materials (e.g., carbon-based separation material) may also contain pores within the material and/or on the surface of the material. The dimensions (e.g., diameter) of the pores may vary. For example, the pores may have a diameter of about 2-50 nm; materials with pores of a diameter of about 2-50 nm are mesoporous materials. For example, the pores may have a diameter of about 0.5-75 nm. Accordingly, in one embodiment the carbon-based material is a mesoporous carbon-based separation material. The geometry of the pores may also vary. For example, the pores may be one-dimensional such as the pores of a carbon nanotube, two-dimensional such as a graphite sheet or layered double hydroxide carbon composites (LDH) or three-dimensional such as the pores of CMK (1-9) .

The class of carbonaceous materials with mesoscopic order (mesoporous) (CMK) were developed as a negative template of ordered mesoporous silica via nanocasting. The paper “Ryoo R., Joo S. H., and Jun S., Synthesis of highly ordered carbon molecular sieves via template-mediated structural transformation, J Phys Chem B 1999; 103: 7743-7746” describes these materials and is incorporated by reference in its entirety. These materials have interesting and beneficial physical and chemical properties, such as large pore volumes, chemical inertness, and large surface area. Each CMK material is uniquely prepared with a different mesoporous silica template and carbon precursor. As a result, these materials exist with varying degree of order, symmetry, and pore size as described in Table 1 as presented by Karakassides in the presentation entitled “Synthesis and characterization of mesoporous carbon hybrids for environmental applications”. For some applications these differences may have a significant effect, however, for other applications the differences may not have a significant effect. The method to separate Pa has been demonstrated with CMK-3 (nanocasted from SBA-15) and CMK-8 (KIT-6), with no visible differences.

TABLE 1
Description of mesoporous carbon materials

| Mesoporous | | Carbon | Pore | Pore |
|---|---|---|---|---|
| Carbon | Silica Template | Precursor | Size (nm) | Dimension |
| CMK-1 | MCM-48 | Sucrose/furfuryl | 3.5 | 3 D |
| | | alcohol (FFA) | | |
| CMK-2 | SBA-1 | Surcrose/FFA | 4.0 | 3 D |
| CMK-3 | SBA-15 | Sucrose/FFA | 4.5 | 1 D |
| CMK-4 | Partially | Surcrose/FFA | 3.0 | 3 D |
| | Disordered | | | |
| | MCM-48 | | | |
| CMK-5 | SBA-15 | FFA | 5.0 | 1 D |
| CMK-8 | KIT-6 | FFA | 4.0 | 3 D |
| SNU-1 | MCM-48 | Sucrose/FFA | 4.0 | 3 D |
| CIC | Colloidal Silica | Mitsbishi | 24 | 1 D |
| | | mesophase pitch | | |
| Mesocarbon | Fe-Silica | FFA | 3.0 | 1 D |
| microwires | | | | |
| FDU-15 | F127 | F-resols | 4 | 1 D |
| FDU-16 | F127 | F-resols | 4.5 | 3 D |
| FDU-17 | PPO-PEO-PPO | Phenolic resol | 3-4.5 | 3 D |
| | | | 5-7 | |
| FDU-18 | PEO-b-PMMA | Resol | 13 | 3 D |

It is to be understood that the separation materials (e.g., carbon-based separation materials) also include separation materials (e.g., carbon-based separation materials) wherein the surface of the separation material may be of a different composition than the bulk composition of the separation material. Thus the separation materials include materials wherein the surface of the material has a composition that is different than the composition of the material not including the surface (e.g., the interior of the material). For example, a carbon-based separation material includes materials wherein the bulk composition of the material (e.g., the material not-including the surface of the material) is predominately carbon and wherein the surface comprises a greater level of oxygen atoms (e.g., the surface of the material comprises more oxygen atoms than the material not on the surface). Thus, in some embodiments the separation material can be considered to be “coated” with an oxidized layer.

The term “coated” generally refers to a separation material (e.g., carbon-based separation material) that has a coating on the surface of the material (as described above) wherein the coating has a different composition than the separation material that it coats. It is to be understood that the term “coated” includes any coating on the separation material regardless of the method or process that gives rise to the coating. Thus a chemically modified surface (e.g., oxidized surface) may be considered a coating. In another embodiment embedding exogenous extraction reagents may also be considered a coating. The separation material may be coated on any surface of the material including the surface of the pores. It is to be understood the surface of the coated separation material may be fully coated or partially coated and that when the coated separation material is partially coated the coating may or may not be contiguous and the coating may be of any shape (e.g., spotted). In one embodiment the surface is at least 1%, at least 10%, at least 20%, at least 40%, at least 60%, at least 80%, at least 90% or completely covered by the substance or material. In one embodiment the separation material is coated with two or more different coatings. The two coatings may each be in contact with the separation material and/or the two coatings may be overlaid (e.g., a second coating is on top of the first coating). The thickness of the coating may be varied and may include thickness of single atoms to multiple atoms.

In one embodiment the separation material (e.g., carbon-based separation material) may be coated with an oxidized layer or oxidized coating. As used herein the oxidized layer refers to a layer on the surface of the separation material that comprises a plurality of oxygen atoms within the layer. In one embodiment the oxidized layer comprises a plurality of hydroxyl groups. In one embodiment the oxidized layer comprises a plurality of carboxyl groups. In one embodiment the oxidized layer comprises a plurality of hydroxyl or carboxyl groups. In one embodiment the oxidized layer comprises a plurality of hydroxyl and carboxyl groups

### Methods of Separation

The separation materials (e.g., carbon-based separation materials) described herein above are useful for separating certain elements and their isotopes (e.g., Pa; including ²³³Pa and ²³¹Pa and Ga; including ⁶⁸Ga) from mixtures that contain the element. As used herein the term “separation” as the term applies to separation of an element such as Pa or Ga means that the element is preferentially separated from the mixture (over other components of the mixture) that contains the element. The separation is the result of the element being selectively associated (e.g., sequestered) with the separation material (e.g., carbon-based separation material). The term “associated” includes any force that results in the element being held together (e.g., in contact) with the separation material (such as absorbed onto). In one embodiment the term associated includes the element being in contact with the separation material. In one embodiment the term associated includes the element being in held together with the separation material but wherein the element is not in direct contact with the separation material. The association of the element with the separation material provides a method to separate the element from the remaining components of the mixture. For example, the mixture can be removed from the separation material via any suitable method such as but not limited to filtration. It is also to be understood the term “separation” includes essentially complete separation of the element from the mixture as well as partial separation of the element from the mixture. Thus, the element may be obtained in essentially pure form or in an enriched form. Likewise, the mixture remaining after the separation may be essentially void of the element being separated or the mixture may have a reduced amount of the element being separated (compared to the amount of the element present in the mixture prior to separation).

The mixture from which the element (e.g., ^{233,231}Pa and ⁶⁸Ga) is separated may comprise a variety components from which it is desirable to separate from the element. For example, in one embodiment Pa (²³³Pa and/or ²³¹Pa) is separated from a mixture comprising Pa (²³³Pa and/or ²³¹Pa) and one or more components selected from actinides (e.g., Th, U, Np, Pu and Am or isotopes thereof), metallic interferences (e.g., metals such as Nb and Fe(II)) or (Fe) and decay products (e.g., ²²⁴Ra, ²²⁰Rn, ²¹⁶Po, ²¹²Pb, ²¹²Bi, ²⁰⁸Tl, ²²⁴Ra, ²²⁰Rn, ²¹⁶Po, ²¹²Pb, ²¹²Bi and ²⁰⁸Tl). In another embodiment Ga (⁶⁸Ga) is separated from a mixture comprising Ga (⁶⁸Ga) and Ge (⁶⁸Ge).

The separations in general can be conducted under acidic conditions using an acid such as a mineral or inorganic acid (e.g., HCl, HNO₃). It has been discovered that Pa (²³³Pa and ²³¹Pa)) and Ga (⁶⁸Ga) are sequestered (e.g., absorbed) by the carbon-based separation material in acidic solutions. In one embodiment the molar concentration of the acid is greater than or about 6 M. Thus the sequestered element can be separated from the mixture, for example, by separating the mixture from the separation material with any suitable method such as a mechanical method (e.g., filtration). The sequestered element can subsequently be released (e.g., desorbed) from the carbon-based separation material by, for example, decreasing the concentration of the acid to below about 6 M. In this manner the sequestered material (e.g., Pa; ^{233,231}Pa or Ga; ⁶⁸Ga) can be recovered from the separation material. It has also been discovered that the sequestered material can be desorbed without using hydrofluoric acid.

In another embodiment Ga (⁶⁸Ga) is separated from a mixture comprising Ga (⁶⁸Ga) and Ge (⁶⁸Ge) using a silicon-based separation material. In one embodiment the separation material is a silica-based separation material. Non-limiting examples of silica-based separation materials include silica gel and mesoporous silica-based separation material.

In one embodiment the method of separation provides the elements or isotopes thereof (e.g., ^{233,231}Pa and ⁶⁸Ga) in enriched form compared to the mixtures from which the element or isotopes thereof (e.g., ^{233,231}Pa and ⁶⁸Ga) are separated wherein the ratio of the element (e.g., molar or weight) in the enriched form versus the element in the mixture (enriched final/mixture) is greater than about 1.05; 1.1; 1.2; 1.3; 1.4; 1.5; 1.7; 2.0; 5; 10; 20; or 30 or greater.

### Embodiments

It is to be understood that the following embodiments can be combined with one or more additional embodiments as described herein and with the embodiments described in the summary of the invention.

In one embodiment the carbon-based separation material has an ordered crystalline structure.

In one embodiment the carbon-based separation material has an ordered one dimensional crystalline structure.

In one embodiment the carbon-based separation material has an ordered two dimensional crystalline structure.

In one embodiment the carbon-based separation material has an ordered three dimensional crystalline structure.

In one embodiment the carbon-based separation material is greater than or about equal to 70% carbon by weight.

In one embodiment the surface of the carbon-based separation material comprises an oxidized coating.

In one embodiment the coating comprises a plurality of oxygen atoms.

In one embodiment the coating comprises a plurality of hydroxyl groups.

In one embodiment the carbon-based separation material is a mesoporous carbon-based separation material.

In one embodiment the mesoporous carbon-based material has pores of about 2-50 nm.

In one embodiment the carbon-based separation material is selected from CMK-1, CMK-2, CMK-3, CMK-4, CMK-5, CMK6, CMK-7, CMK8 and CMK-9.

In one embodiment the carbon-based separation material is CMK-3.

In one embodiment the mixture is contacted with the carbon-based separation material in the presence of acid.

In one embodiment the acid is an inorganic acid.

In one embodiment the concentration of the acid is greater than or equal to about 6 M.

In one embodiment the Pa or Ga or isotopes thereof associated with the carbon-based separation material is further separated from the mixture to provide a separated carbon-based separation material associated with the Pa or Ga or isotopes thereof

In one embodiment the Pa or Ga or isotopes thereof are released from the separated carbon-based separation material associated with the Pa or Ga or isotopes thereof.

One embodiment provides a method for separating Pa or isotopes thereof from a mixture comprising Pa or isotopes thereof, which method comprises contacting the mixture with a carbon-based separation material.

One embodiment provides a method for separating ²³³Pa and/or ²³¹Pa from a mixture comprising ²³³Pa and/or ²³¹Pa , which method comprises contacting the mixture with a carbon-based separation material.

One embodiment provides a method for separating ²³³Pa from a mixture comprising ²³³Pa, which method comprises contacting the mixture with a carbon-based separation material.

One embodiment provides a method for separating ²³¹Pa from a mixture comprising ²³¹Pa , which method comprises contacting the mixture with a carbon-based separation material.

One embodiment provides a method for separating ²³³Pa and ²³¹Pa from a mixture comprising ²³³Pa and ²³¹Pa , which method comprises contacting the mixture with a carbon-based separation material.

In one embodiment the mixture being separated further contains one or more components independently selected from actinides, decay products and other metals

In one embodiment the mixture being separated further includes actinides which are independently selected from ²⁴¹Am, ²³⁹Pu, ²³⁷Np, ²³²U, ²²⁹Th and ²²⁸Th.

In one embodiment the mixture being separated further includes decay products, which are independently selected from ²²⁴Ra, ²²⁰Rn, ²¹⁶Po, ²¹²Pb, ²¹²Bi, ²⁰⁸Tl, ²²⁴Ra, ²²⁰Rn, ²¹⁶Po, ²¹²Pb, ²¹²Bi and ²⁰⁸Tl.

In one embodiment the mixture being separated further includes other metals which are independently selected from Nb and Fe(II).

In one embodiment the mixture being separated further includes other metals which are independently selected from Nb and Fe.

One embodiment provides a method for separating Ga or isotopes thereof from a mixture comprising Ga including isotopes thereof, which method comprises contacting the mixture with a carbon-based separation material.

One embodiment provides a method for separating ⁶⁸Ga from a mixture comprising ⁶⁸Ga, which method comprises contacting the mixture with a carbon-based separation material.

One embodiment provides a method for separating ⁶⁸Ga from a mixture comprising ⁶⁸Ga and ⁶⁸Ge, which method comprises contacting the mixture with a carbon-based separation material.

One embodiment provides a method for separating ⁶⁸Ga from a mixture comprising ⁶⁸Ga and Zn, which method comprises contacting the mixture with a carbon-based separation material.

One embodiment provides a method for separating ⁶⁸Ga from a mixture comprising ⁶⁸Ga and Fe, which method comprises contacting the mixture with a carbon-based separation material.

One embodiment provides a composition comprising Pa or isotopes thereof and a carbon-based separation material.

One embodiment provides a composition comprising ²³³Pa and/or ²³¹Pa and a carbon-based separation material.

One embodiment provides a composition comprising ²³³Pa and ²³¹Pa and a carbon-based separation material.

One embodiment provides a composition comprising ²³³Pa and a carbon-based separation material.

One embodiment provides a composition comprising ²³¹Pa and a carbon-based separation material.

One embodiment provides a composition comprising Ga or isotopes thereof and a carbon-based separation material.

One embodiment provides a composition ⁶⁸Ga and a carbon-based separation material.

One embodiment provides a composition consisting essentially of an isotope of an element and a carbon-based separation material.

One embodiment provides a composition comprising one or more Pa or Ga isotopes (e.g., ^{233,231}Pa and ⁶⁸Ga) and a carbon-based separation material.

One embodiment provides a composition comprising one or more Pa isotopes (e.g., ^{233,}Pa, ²³¹Pa) and a carbon-based separation material.

One embodiment provides a composition consisting essentially of ²³³Pa and a carbon-based separation material.

One embodiment provides a composition consisting essentially ²³¹Pa and a carbon-based separation material.

One embodiment provides a composition consisting essentially ⁶⁸Ga and a carbon-based separation material.

In one embodiment any of the above described compositions may be characterized in that the composition is isolated.

The invention will now be illustrated by the following non-limiting Example.

### EXAMPLE 1

### Experimental Procedure to Separation ²³³Pa from the Actinides and Other Metallic Interferences

### Materials

The elution curve profile data demonstrating the separation of Pa from the actinides and other metallic interferences was performed by column chromatography and analyzed by gamma spectroscopy and liquid scintillation counting. Radiometric liquid standards were prepared as described previously (Knight, A. W., et al., (2014). “A Simple-Rapid Method to Separate Uranium, Thorium, and Protactinium for U-Series Age-Dating of Materials.” Journal of Environmental Radioactivity 134(JENR4454): 66-74). The radiometric liquid standards used in this study were ²³⁷Np (t_{1/2}=2.14×10⁶ years) in secular equilibrium with ²³³Pa (t_{1/2}=26.9 days); ²³²U (t_{1/2}=68.9 years) in secular equilibrium with ²²⁸Th (t_{1/2}=1.91 years) and short-lived ²²⁸Th decay products (²²⁴Ra, ²²⁰Rn, ²¹⁶Po, ²¹²Pb, ²¹²Bi, ²¹²Po); ²²⁹Th (t_{1/2}=7357 years) in secular equilibrium with short-lived decay products (²²⁵Ra, ²²⁵Ac, ²²¹Fr, ²¹⁷At, ²¹³Bi, ²⁰⁹Tl); ²⁴¹Am (t_{1/2}=432.2 years); ²³⁹Pu (t_{1/2}=24,100 years) which were purchased from either the United States National Institute of Standards and Technology or Eckert and Ziegler. The mesoporous carbon material (CMK-3; BET1000) was purchased from ACS Materials. All acids used (hydrochloric acid, HCl; nitric acid, HNO₃) were of ACS grade or higher.

### Counting Methods

### Liquid Scintillation Counting:

Liquid scintillation counting was performed on a Packard (1600 CA Tri-Carb) LS counter using Ecolite LS cocktail in glass LS vials with approximately 10% water fraction. Each vial was counted for 60 minutes using a standard protocol, and background subtracted using a blank of similar matrix.

### Gamma Spectroscopy:

All gamma spectroscopic measurements were performed on a well-type sodium iodide (NaI) detector equip with a Digibase™ (Ortec) and Maestro Software (Ortec). The detector is encased in a silo of lead for shielding ambient gamma rays. All measurements were made using the recommended high voltage of 800 V. The energies have been calibrated with a two-point calibration curve using ¹³⁷Cs and ¹⁵²Eu calibrated sources. For each analysis, the sample was placed in the well and the silo was closed. The samples were counted for 250 seconds and background subtracted with a match-time background spectra. The net integrated counts were recorded for each sample vial. The radionuclide identification was determine by primary gamma ray energy values originating from the Evaluated Nuclear Structure Data File (ENSDF) and were obtained though the United States National Nuclear Data Center (NNDC, Brookhaven National Laboratory, US Department of Energy). Table 1 shows the primary gamma ray energy peaks used to identify each radionuclide. All radionuclides not shown in Table 1 were analyzed alone by liquid scintillation counting.

TABLE 1
The primary gamma energies to identify selected radionuclides
by NaI gamma spectroscopy. The branching ratio can correlate
the count rate (counts/sec) to radioactivity (decays/sec).

| Radionuclide | Gamma Energy (keV) | Branching (%) |
|---|---|---|
| ²³³Pa | 311 | 38.5 |
| ²³⁷Np | 86 | 12.4 |
| ²⁴¹Am | 59 | 35.9 |
| ²²⁹Th | 88 | 23.9 |
| ²²⁴Ra | 240 | 4.1 |
| ²¹²Pb | 238 | 43.6 |

### Procedure

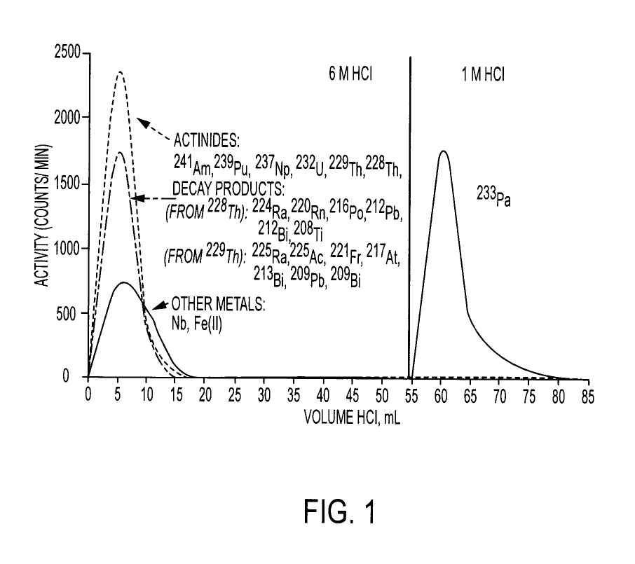

To obtain the elution curve for each element of interest, 0.100 grams of CMK-3 was weighed out into the bottom of a 2 mL empty column (AC-141-AL, Eichrom Technologies, LLC) and the CMK-3 was packed tightly with a frit on top, the column was completed with a 25 mL reservoir (AC-120, Eichrom Technologies). Then the column was precondition with 25 mL of 6 M HCl to fully convert the material to the chloride form. Aliquots of each analyte were dissolved into 5 mL of 6 M HCl in a 30 mL liquid scintillation vial and analyzed by gamma spectroscopy for the initial activity added to the column. The load solution was added to the column and was collected into a 30 mL liquid scintillation vial and analyzed by gamma spectroscopy to determine the activity eluted from the column of each particular analyte in the first 5 mL. Then, 5 mL of 6 M HCl was added to the column and collected in a 30 mL liquid scintillation vial, again the contents were analyzed by gamma spectroscopy. This procedure was repeated for 55 mL (where only Pa remained adsorbed to the column). Then 5 mL of 1 M HCl was added to the column and collected in a 30 mL liquid scintillation vial and analyzed by gamma spectroscopy. Once all of the fractions have been collected, 15 mL of liquid scintillation cocktail was added to each vial and counted by liquid scintillation counting. This was done as a confirmation that each fraction had the correct identification of radionuclide and activity. Because some of the radionuclides do not emit a gamma particle measureable by gamma spectroscopy, it was necessary to confirm the elution of these radionuclides by liquid scintillation counting. The resulting data from the liquid scintillation counting is shown in FIG. 1.

All publications, patents, and patent documents discussed herein are incorporated by reference herein, as though individually incorporated by reference. The invention has been described with reference to various specific and preferred embodiments and techniques. However, it should be understood that many variations and modifications may be made while remaining within the spirit and scope of the invention.

1. A method for separating protactinium or gallium or isotopes thereof from a corresponding mixture comprising protactinium or gallium or isotopes thereof, which method comprises contacting the mixture with a carbon-based separation material.

2-4. (canceled)

5. The method of claim 1, wherein the carbon-based separation material has an ordered three dimensional crystalline structure.

6. The method of claim 1, wherein the carbon-based separation material is greater than or about equal to 70% carbon by weight.

7-9. (canceled)

10. The method of claim 1, wherein the carbon-based separation material is a mesoporous carbon-based separation material.

11. The method of claim 10, wherein the mesoporous carbon-based material has pores of about 2-50 nm in diameter.

12. The method of claim 1, wherein the carbon-based separation material is CMK-3.

13. The method of claim 1, wherein the mixture is contacted with the carbon-based separation material in the presence of acid.

14-15. (canceled)

16. The method of claim 1, wherein the protactinium or gallium or isotopes thereof associated with the carbon-based separation material is further separated (isolated) from the mixture to provide a separated (isolated) carbon-based separation material associated with the protactinium or gallium or isotopes thereof

17. The method of claim 16, further comprising releasing the protactinium or gallium or isotopes thereof from the separated carbon-based separation material associated with the protactinium or gallium or isotopes thereof.

18. The method of claim 1, for separating protactinium or isotopes thereof from a mixture comprising protactinium or isotopes thereof, which method comprises contacting the mixture with a carbon-based separation material.

19-21. (canceled)

22. The method of claim 18, wherein the mixture further contains one or more components independently selected from actinides, decay products and other metals.

23-25. (canceled)

26. The method of claim 1, for separating gallium or isotopes thereof from a mixture comprising gallium including isotopes thereof, which method comprises contacting the mixture with a carbon-based separation material.

27-28. (canceled)

29. A composition comprising protactinium or gallium or isotopes thereof and a carbon-based separation material.

30. The composition of claim 29 comprising protactinium or isotopes thereof and a carbon-based separation material.

31. The composition of claim 29 consisting essentially of protactinium or isotopes thereof and a carbon-based separation material.

32-37. (canceled)

38. The composition of claim 29 comprising gallium or isotopes thereof and a carbon-based separation material.

39. (canceled)

40. The composition of claim 29 consisting essentially of ⁶⁸Ga and a carbon-based separation material.

41-44. (canceled)

45. The composition of claim 29, wherein the carbon-based separation material is greater than or about equal to 70% carbon by weight.

46-48. (canceled)

49. The composition of claim 29, wherein the carbon-based separation material is a mesoporous carbon-based separation material.

50. (canceled)

51. The composition of claim 29, wherein the carbon-based separation material is CMK-3.
